(19) United States
(12) Patent Application Publication
(10) Pub. No.: US 2013/0284112 A1
(43) Pub. Date: Oct. 31, 2013

(54) Toy for a Cat or Other Small Animal with Multiple Levels of Play Difficulty

(71) Applicant: Andrey Yuriy Grigoryev, Fort Lee, NJ (US)

(72) Inventor: Andrey Yuriy Grigoryev, Fort Lee, NJ (US)

(21) Appl. No.: 13/867,115

(22) Filed: Apr. 21, 2013

Related U.S. Application Data
(60) Provisional application No. 61/638,435, filed on Apr. 25, 2012.

(51) Int. Cl. A01K 15/02

(52) U.S. Cl. CPC A01K 15/025
USPC 119/707

(57) ABSTRACT

A toy for a cat or other small animal, comprising a container with regions of interior space that have distinct levels of play difficulty, determined by the number, size, and position of openings that enable access to a reward that may be placed within the toy.

### BACKGROUND OF THE INVENTION

The present invention is in the technical field of pet accessories. More particularly, the present invention is in the technical field of pet toys.

Cats and other small animals kept for companionship, also known as pets, are playful, curious, intelligent animals and require stimulus in the form of play. It is common for such play to be encouraged and facilitated through the use of toys. There exists a plurality of toys for cats and other small animals, offering various forms of stimulus to the player. A plurality of these toys has reward-retrieval play patterns. For the purposes of this document, a reward-retrieval play pattern is defined as gameplay wherein the player's objective is to find and extract a concealed reward. The term reward, as used in this document, refers to an object that is intended to attract the interest of a cat or other small animal, such as a small toy or edible treat.

Existing toys for cats and other small animals with reward-retrieval play patterns comprise a container with an undivided interior space and a uniform and invariable pattern of openings on the surface of the container. Because the openings that enable access to the reward are uniform, and uniformly spaced on the surface of the container, the actions required to extract the reward are the same or similar for every portion of the container. Therefore, such toys with reward-retrieval play patterns currently each have only a single level of play difficulty. Play difficulty is defined in this document as the degree of challenge in extracting a reward from the toy.

Toys with only one level of play difficulty cease to be challenging for the player sooner than toys with multiple levels of play difficulty. When a player masters gameplay at a certain level of play difficulty, the player loses interest in continuing gameplay at that level of difficulty. Therefore, toys with multiple levels of play difficulty keep players interested and engaged longer than toys with only one level of play difficulty. Hence, a heretofore unaddressed need exists in the industry to address the aforementioned deficiencies and inadequacies.

### SUMMARY OF THE INVENTION

The present invention is a toy for a cat or other small animal, with multiple levels of play difficulty. It is comprised of a polyhedron container with a hollow interior and at least one hole in its surface. The interior space of the container comprises one or more regions. The regions should have approximately the same shape and volume, however regions with relatively different shapes and volumes are contemplated. These regions may be fully or partially separated within the container by one or more insert(s) positioned inside the container, or by portions of the container that protrude into the interior space of the container.

Each region of the interior space of the container is a distinct level of play difficulty. The level of play difficulty of each region is determined by the number, size, and relative placement of the holes that enable access to that region.

More specifically, play difficulty is determined by one or any combination of the following factors:

1. The size of the holes; holding other factors constant, as the size of a hole that enables access to a region decreases, the play difficulty of that region increases.

2. The number of holes; holding other factors constant, as the number of the holes that enable access to a region decreases, the play difficulty of that region increases.

3. The position of the holes relative to the edges of the container; holding other factors constant, as the vertical distance between a hole on a vertical face of the container and the bottom edge of the container increases, the play difficulty of the region that the hole enables access to increases; holding other factors constant, as the distance between a hole on the top face of the container and the nearest edge of the container increases, the play difficulty of the region that the hole enables access to increases.

4. The position of the holes relative to each other; holding other factors constant, as the distance between holes that enable access to a region increases, the play difficulty of that region increases.

Altering one or any combination of the above listed factors alters the level of play difficulty. In a toy of the present invention, the above listed factors may be altered by manipulating the configuration of the components of the toy. Therefore, each region of the inner space of a toy of the present invention may have different levels of play difficulty for different configurations of the components of the toy. Changing the relative configuration of the components of a toy of the present invention may change the level of play difficulty of all or part of the toy.

### BRIEF DESCRIPTION OF THE DRAWINGS

Many aspects of the invention can be better understood with reference to the associated drawings. The components in the drawings are not necessarily to scale, emphasis instead being placed upon clearly illustrating the principles of the invention. Moreover, in the drawings, like reference numerals designate corresponding parts throughout the several views.

FIG. 1 is a perspective view of a toy of the present invention;

FIG. 2 is a perspective view of the components of the invention as shown in FIG. 1

FIG. 3 is a perspective view of a toy of the present invention;

FIG. 4 is a perspective view of the components of the invention as shown in FIG. 3

FIG. 5 is a perspective view of a toy of the present invention;

FIG. 6 is a perspective view of the components of the invention as shown in FIG. 5

FIG. 7 is a perspective view of a toy of the present invention;

FIG. 8 is a perspective view of the components of the invention as shown in FIG. 7

FIG. 9 is a perspective view of a toy of the present invention;

FIG. 10 is a perspective view of the components of the invention as shown in FIG. 9

FIG. 11 is a perspective view of a toy of the present invention;

FIG. 12 is a perspective view of the components of the invention as shown in FIG. 11

FIG. 13 is a perspective view of a toy of the present invention;

FIG. 14 is a perspective view of a toy of the present invention with the insert 266 rotated 180 degrees in the horizontal plane relative to its position in FIG. 13;

FIG. 15 is a perspective view of the components of the invention as shown in FIG. 13 and FIG. 14

FIG. 16 is a perspective view of a toy of the present invention;

FIG. 17 is a perspective view of a toy of the present invention with the insert 230 rotated 180 degrees in the horizontal plane relative to its position in FIG. 16;

FIG. 18 is a perspective view of the components of the invention as shown in FIG. 16 and FIG. 17

FIG. 19 is a perspective view of a toy of the present invention;

FIG. 20 is a perspective view of a toy of the present invention with the insert 306 rotated 180 degrees in the horizontal plane relative to its position in FIG. 19;

FIG. 21 is a perspective view of the components of the invention as shown in FIG. 19 and FIG. 20

FIG. 22 is a perspective view of a toy of the present invention;

FIG. 23 is a perspective view of a toy of the present invention with the insert 370 rotated 180 degrees in the horizontal plane relative to its position in FIG. 22;

FIG. 24 is a perspective view of the components of the invention as shown in FIG. 22 and FIG. 23

FIG. 25 is a perspective view of a toy of the present invention;

FIG. 26 is a perspective view of a toy of the present invention with the insert rotated in the horizontal plane relative to its position in FIG. 25;

FIG. 27 is a perspective view of the components of the invention as shown in FIG. 25 and FIG. 26

### DETAILED DESCRIPTION OF THE INVENTION

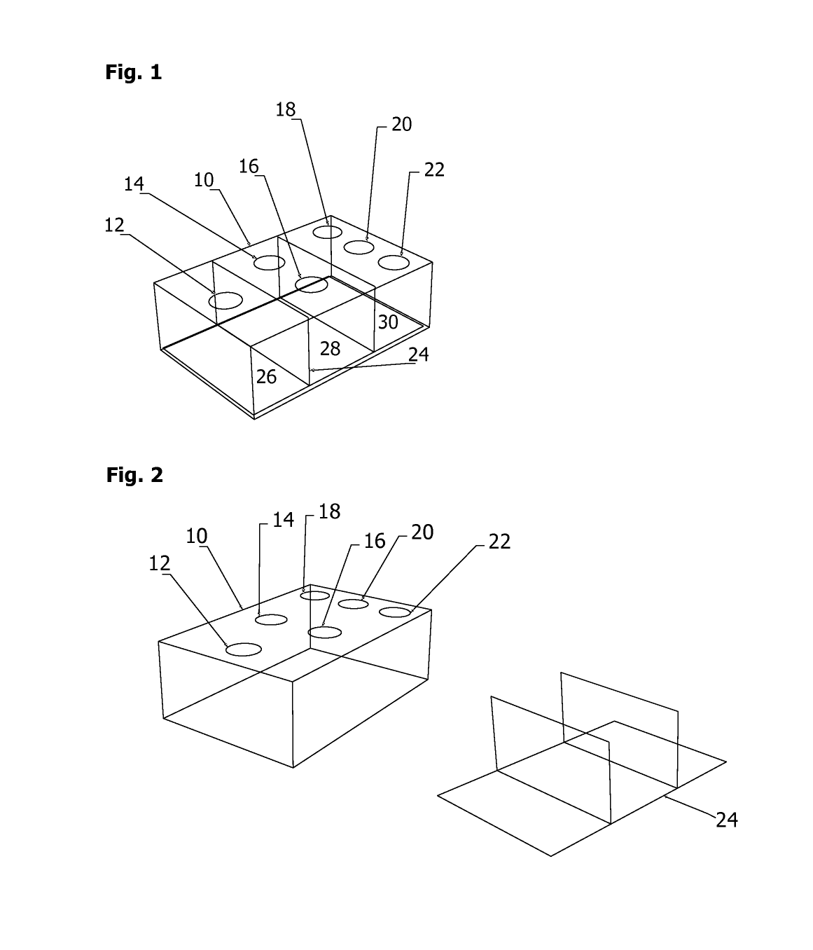

Referring now to the invention in more detail, in FIG. 1 there is shown a toy having a container 10 with holes 12, 14, 16, 18, 20, 22 on its surface and an insert 24 inside the container 10.

In the invention as shown in FIG. 1, the interior space of the container comprises regions 26, 28, 30 of non-equal play difficulty. In the invention as shown in FIG. 1, these regions 26, 28, 30 are circumscribed by the inner surface of the container and the faces of the insert. The container surface that circumscribes each region 26, 28, 30 has one or more holes 12, 14, 16, 18, 20, 22 that enable(s) access to that region. Each region 26, 28, 30 has a different number of holes that enable access to it.

Still referring to the invention as shown in FIG. 1, each region 26, 28, 30 is a distinct level of play difficulty. The level of play difficulty of each region 26, 28, 30 is determined by the number of holes that enable access to that region. The region 30 of the easiest level of play difficulty is the region with the greatest number of holes that enable access to that region. The region 26 of the hardest level of play difficulty is the region with the least number of holes that enable access to that region.

In further detail, still referring to the invention as shown in FIG. 1, the container 10 is of a sufficient volume for an average cat, or other small animal, to play with it comfortably, such as about 100 to 6000 cubic inches. Each hole 12, 14, 16, 18, 20, 22 on the container 10 is of a sufficient size to allow an average cat, or other small animal, to put its paw—but not its head—through it, such as about 0.5 to 3 inches in diameter, or about 0.5 to 3 inches in the longest dimension.

The construction details of the invention as shown in FIG. 1 are that the container 10 and insert 24 may be made of lightweight, solid material (such as cardboard, plywood, plastic) or a fabric material stretched over a solid frame. One or more of the faces on the container 10 can be opened or detached to enable the placement, removal, or adjustment of the insert 24.

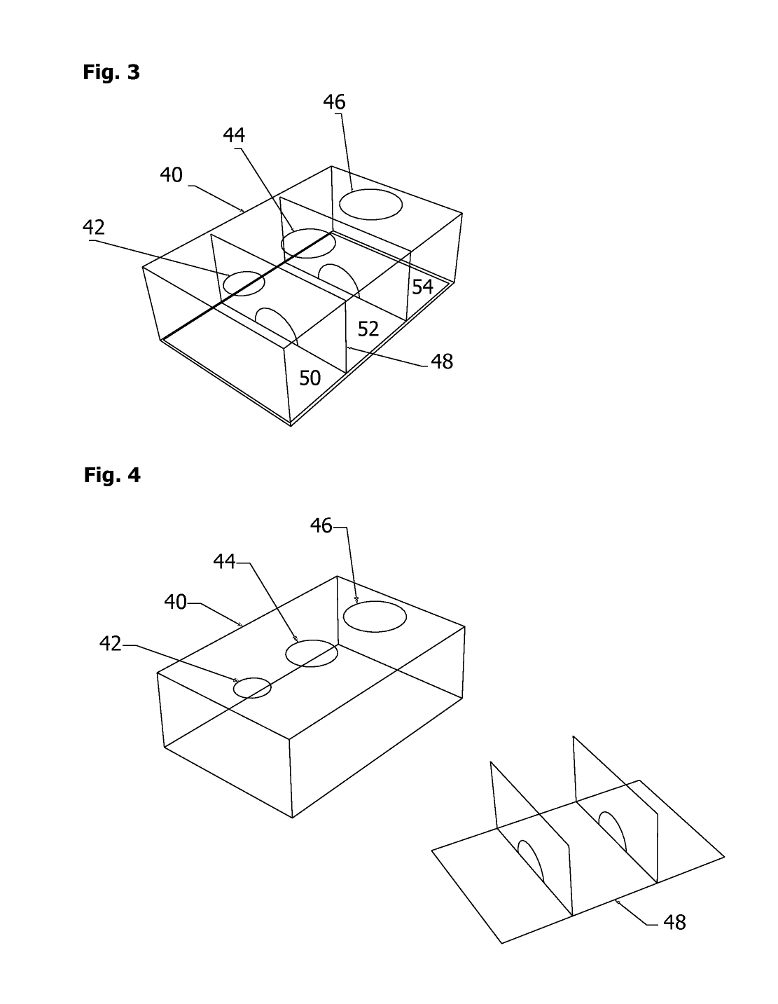

In FIG. 3 there is shown a toy having a container 40 with holes 42, 44, 46 on its surface and an insert 48 inside the container 40.

In the invention as shown in FIG. 3, the interior space of the container comprises regions 50, 52, 54 of non-equal play difficulty. In the invention as shown in FIG. 3, these regions 50, 52, 54 are circumscribed by the inner surface of the container and the faces of the insert. The container surface that circumscribes each region 50, 52, 54 has a hole 42, 44, 46 that enables access to that region. The size of the hole 42, 44, 46 is different for each region 50, 52, 54.

Still referring to the invention as shown in FIG. 3, each region 50, 52, 54 is a distinct level of play difficulty. The level of play difficulty of each region 50, 52, 54 is determined by the size of the hole 42, 44, 46 on the container surface that enables access to that region. The region of the easiest level of play difficulty 54 is the region with the largest hole 46 that enables access to that region. The region of the hardest level of play difficulty 50 is the region with the smallest hole 42 that enables access to that region.

In further detail, still referring to the invention as shown in FIG. 3, the container 40 is of a sufficient volume for an average cat, or other small animal, to play with it comfortably, such as about 100 to 6000 cubic inches. Each hole 42, 44, 46 on the container 40 is of a sufficient size to allow an average cat, or other small animal, to put its paw—but not its head—through it, such as about 0.5 to 3 inches in diameter, or about 0.5 to 3 inches in the longest dimension.

The construction details of the invention as shown in FIG. 3 are that the container 40 and insert 48 may be made of lightweight, solid material (such as cardboard, plywood, plastic) or a fabric material stretched over a solid frame. One or more of the faces on the container 40 can be opened or detached to enable the placement, removal, or adjustment of the insert 48.

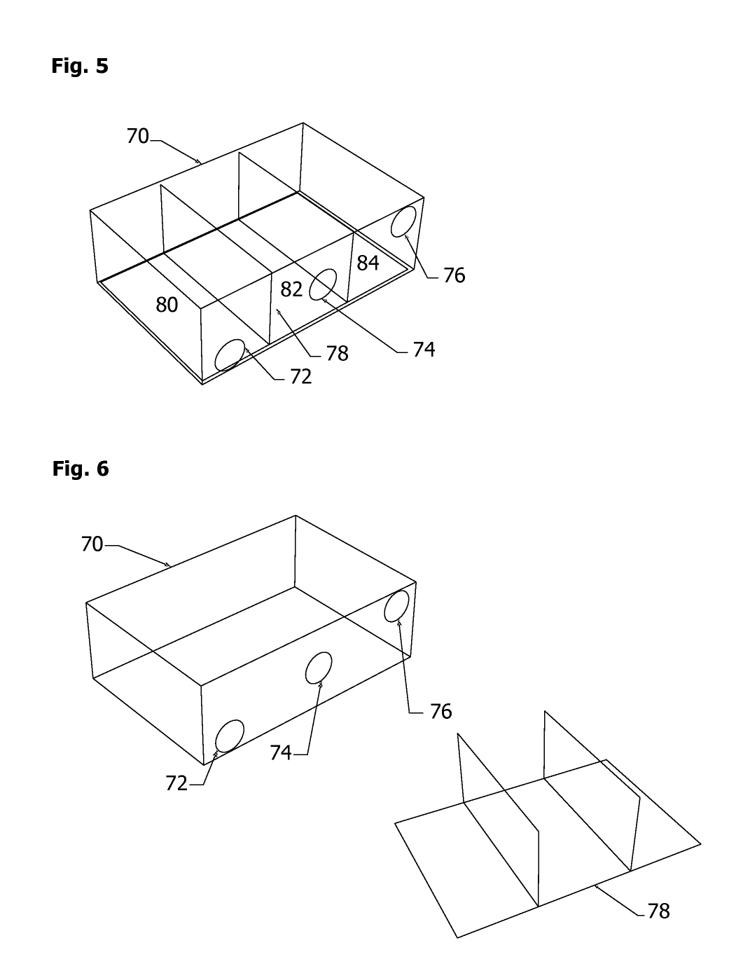

In FIG. 5 there is shown a toy having a container 70 with holes 72, 74, 76 on its vertical face and an optional insert 78 inside the container 70.

In the invention as shown in FIG. 5, the interior space of the container comprises regions 80, 82, 84 of non-equal play difficulty. In the invention as shown in FIG. 5, these regions 80, 82, 84 are circumscribed by the inner surface of the container and the faces of the insert. The container surface that circumscribes each region 80, 82, 84 has a hole 72, 74, 76 that enables access to that region. The distance between the hole 72, 74, 76 and the bottom face of the container is different for each region 80, 82, 84.

Still referring to the invention as shown in FIG. 5, each region 80, 82, 84 is a distinct level of play difficulty. The level of play difficulty of each region 80, 82, 84 is determined by the distance between the hole 72, 74, 76 that enables access to that region and the bottom face of the container. The region of the easiest level of play difficulty 80 is the region with the least distance between the hole 72 that enables access to that region and the bottom face of the container. The region of the hardest level of play difficulty 84 is the region with the greatest distance between the hole 76 that enables access to that region and the bottom face of the container.

In further detail, still referring to the invention as shown in FIG. 5, the container 70 is of a sufficient volume for an average cat, or other small animal, to play with it comfortably, such as about 100 to 6000 cubic inches. Each hole 72, 74, 76 on the container 40 is of a sufficient size to allow an average cat, or other small animal, to put its paw—but not its head—through it, such as about 0.5 to 3 inches in diameter, or about 0.5 to 3 inches in the longest dimension.

The construction details of the invention as shown in FIG. 3 are that the container 70 and insert 78 may be made of lightweight, solid material (such as cardboard, plywood, plastic) or a fabric material stretched over a solid frame. One or more of the faces on the container 70 can be opened or detached to enable the placement, removal, or adjustment of the insert 78.

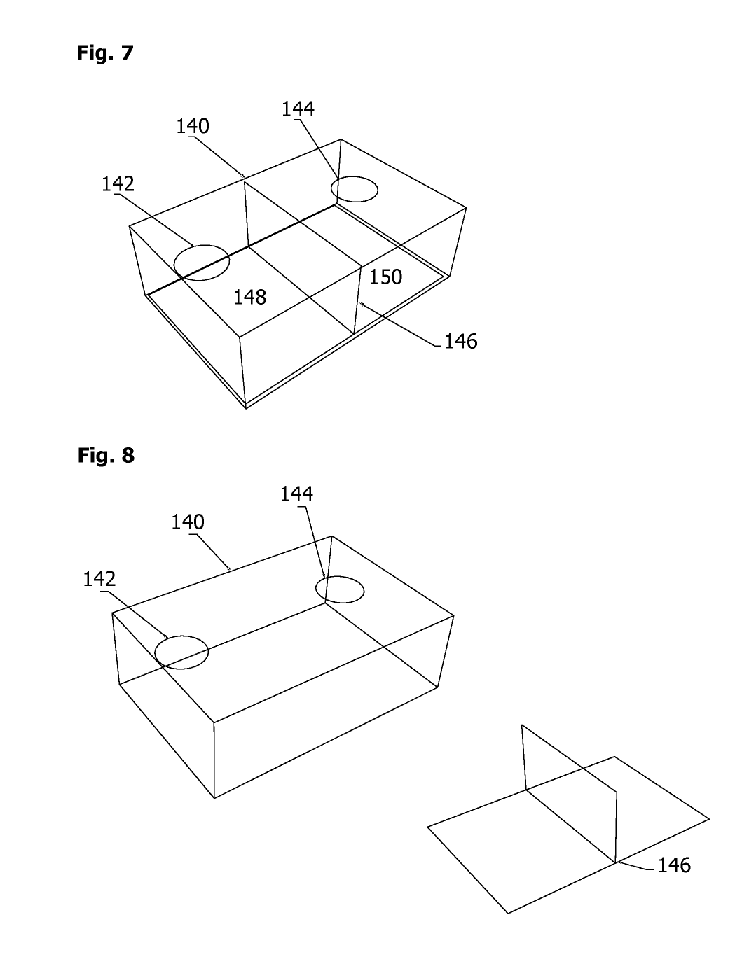

In FIG. 7 there is shown a toy having a container 140 with holes 142, 144 on its top face and an optional insert 146 inside the container 140.

In the invention as shown in FIG. 7, the interior space of the container comprises regions 148, 150 of non-equal play difficulty. In the invention as shown in FIG. 7, these regions 148, 150 are circumscribed by the inner surface of the container and the faces of the insert. The container surface that circumscribes each region 148, 150 has a hole 142, 144 that enables access to that region. The distance between the hole 142, 144 and the nearest vertical face of the container is different for each region 148, 150.

Still referring to the invention as shown in FIG. 7, each region 148, 150 is a distinct level of play difficulty. The level of play difficulty of each region 148, 150 is determined by the distance between the hole 142, 144 that enables access to that region and the nearest vertical face of the container. The region of the easiest level of play difficulty 148 is the region with the least distance between the hole 142 that enables access to that region and the nearest vertical face of the container. The region of the hardest level of play difficulty 150 is the region with the greatest distance between the hole 144 that enables access to that region and the nearest vertical face of the container.

In further detail, still referring to the invention as shown in FIG. 7, the container 140 is of a sufficient volume for an average cat, or other small animal, to play with it comfortably, such as about 100 to 6000 cubic inches. Each hole 142, 144 on the container 140 is of a sufficient size to allow an average cat, or other small animal, to put its paw—but not its head—through it, such as about 0.5 to 3 inches in diameter, or about 0.5 to 3 inches in the longest dimension.

The construction details of the invention as shown in FIG. 7 are that the container 140 and insert 146 may be made of lightweight, solid material (such as cardboard, plywood, plastic) or a fabric material stretched over a solid frame. One or more of the faces on the container 140 can be opened or detached to enable the placement, removal, or adjustment of the insert 146.

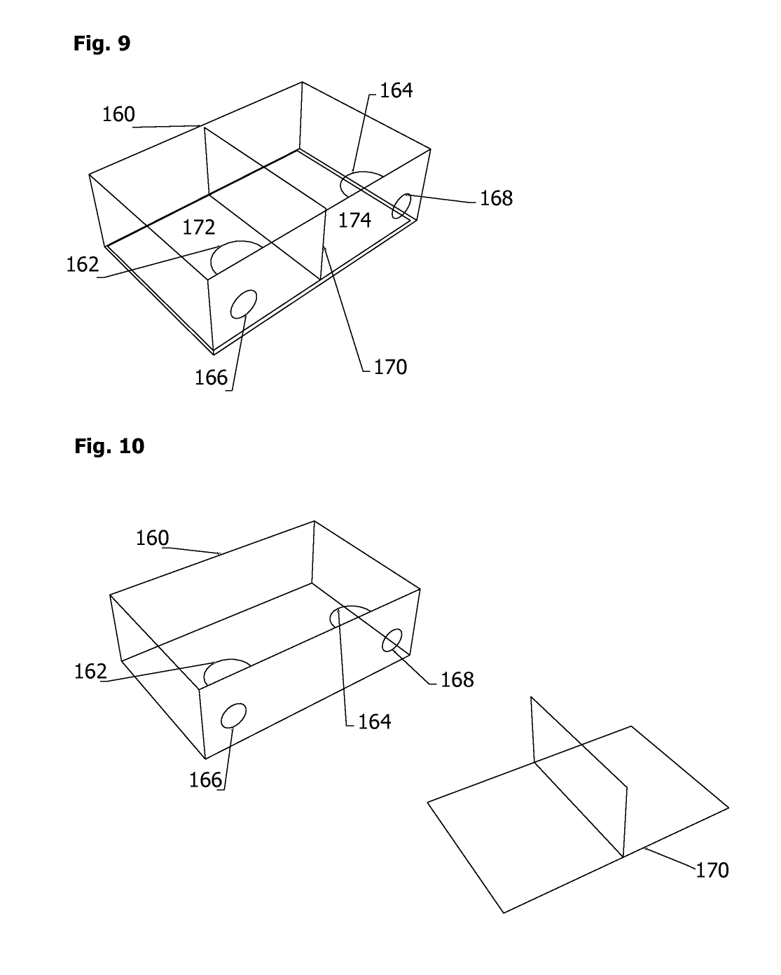

In FIG. 9 there is shown a toy having a container 160 with holes 162, 164, 166, 168 on its surface and an insert 170 inside the container 160.

In the invention as shown in FIG. 9, the interior space of the container comprises regions 172, 174 of non-equal play difficulty. In the invention as shown in FIG. 9, these regions 172, 174 are circumscribed by the inner surface of the container and the faces of the insert. The container surface that circumscribes each region 172, 174 has one hole 166, 168 on the vertical portion of the container surface, and one hole 162, 164 on the top horizontal portion of the container surface. The horizontal distance between the holes 162, 164, 166, 168 is different for each region 172, 174.

Still referring to the invention as shown in FIG. 9, each region 172, 174 is a distinct level of play difficulty. The level of play difficulty of each region 172, 174 is determined by the horizontal distance between the holes 162, 164, 166, 168 that enable access to that region. The region of the easiest level of play difficulty 172 is the region with the least horizontal distance between the holes 162, 166 that enable access to that region. The region of the hardest level of play difficulty 174 is the region with the greatest horizontal distance between the holes 164, 168 that enable access to that region.

In further detail, still referring to the invention as shown in FIG. 9, the container 160 is of a sufficient volume for an average cat, or other small animal, to play with it comfortably, such as about 100 to 6000 cubic inches. Each hole 162, 164, 166, 168 on the container 160 is of a sufficient size to allow an average cat, or other small animal, to put its paw—but not its head—through it, such as about 0.5 to 3 inches in diameter, or about 0.5 to 3 inches in the longest dimension.

The construction details of the invention as shown in FIG. 9 are that the container 160 and insert 170 may be made of lightweight, solid material (such as cardboard, plywood, plastic) or a fabric material stretched over a solid frame. One or more of the faces on the container 160 can be opened or detached to enable the placement, removal, or adjustment of the insert 170.

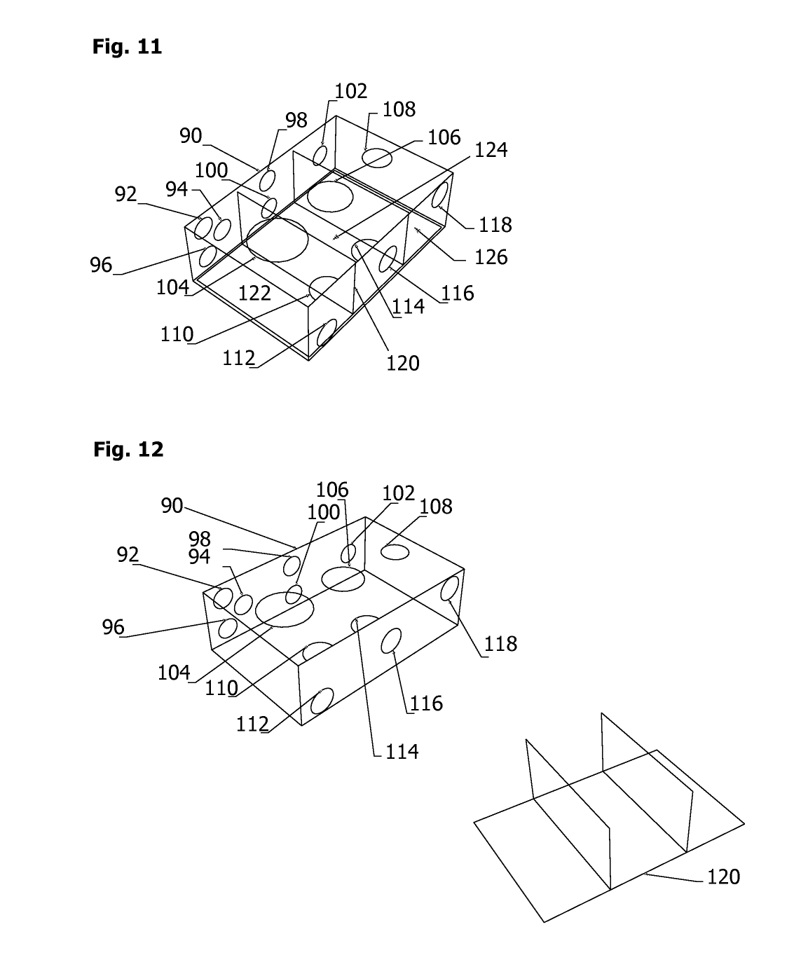

In FIG. 11 there is shown a toy having a container 90 with holes 92, 94, 96, 98, 100, 102, 104, 106, 108, 110, 112, 114, 116, 118 on its surface and an insert 120 inside the container 90.

In the invention as shown in FIG. 11, the interior space of the container comprises regions 122, 124, 126 of non-equal play difficulty. In the invention as shown in FIG. 11, these regions 122, 124, 126 are circumscribed by the inner surface of the container and the faces of the insert.

Still referring to the invention as shown in FIG. 11, each region 122, 124, 126 is a distinct level of play difficulty. The level of play difficulty of each region 122, 124, 126 is determined by a combination of the factors that determine the difficulty level of regions in the invention as shown in FIGS. 1, 2, 3, 4, 5.

In further detail, still referring to the invention as shown in FIG. 11, the container 90 is of a sufficient volume for an average cat, or other small animal, to play with it comfortably, such as about 100 to 6000 cubic inches. Each hole 92, 94, 96, 98, 100, 102, 104, 106, 108, 110, 112, 114, 116, 118 on the container 90 is of a sufficient size to allow an average cat, or other small animal, to put its paw—but not its head—through it, such as about 0.5 to 3 inches in diameter, or about 0.5 to 3 inches in the longest dimension.

The construction details of the invention as shown in FIG. 11 are that the container 90 and insert 120 may be made of lightweight, solid material (such as cardboard, plywood, plastic) or a fabric material stretched over a solid frame. One or more of the faces on the container 90 can be opened or detached to enable the placement, removal, or adjustment of the insert 120.

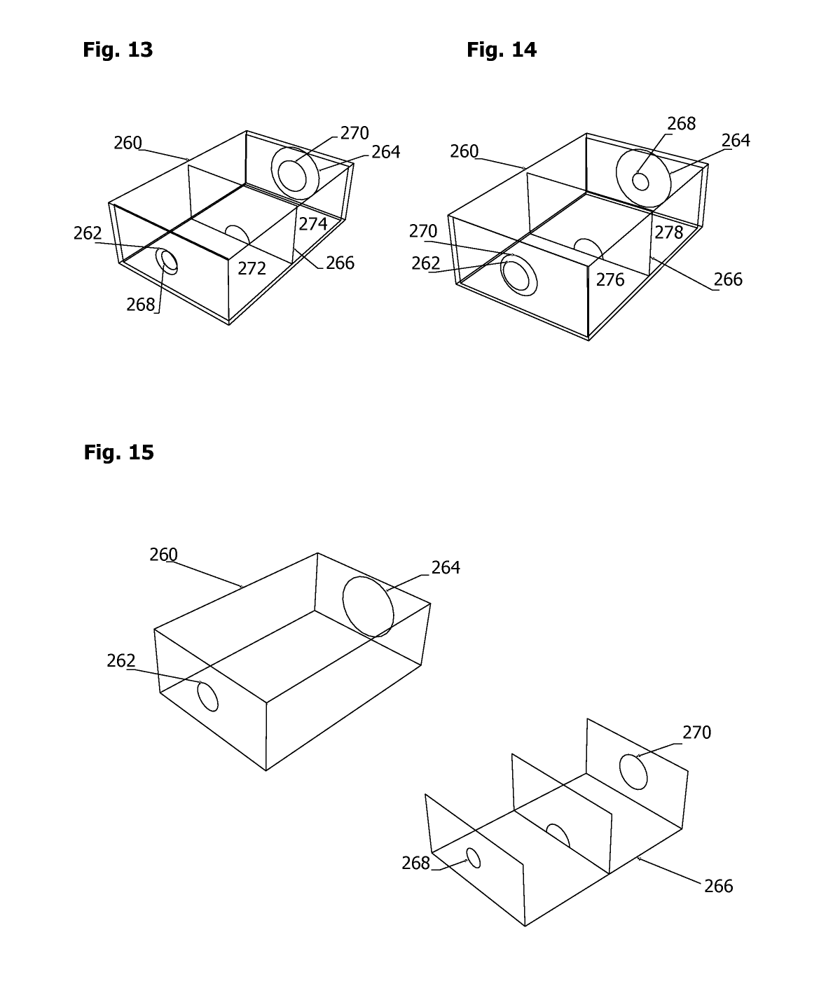

In FIG. 13 there is shown a toy having a container 260 with holes 262, 264 on its vertical faces and an insert 266 inside the container 260 with holes 268, 270 on its outermost vertical faces. The outermost vertical faces of the insert overlay the vertical faces of the container. The overlaps of the holes 268, 270 on the insert 266 and the holes 262, 264 on the container 260 result in openings that enable access to the interior of the container.

In the invention as shown in FIG. 14 the insert 266 is shown rotated 180 degrees in the horizontal plane relative to its position in FIG. 13, so that:
The hole 264 on the container 260 that is partially obstructed by the insert 266 as positioned in FIG. 13 is obstructed to a greater degree by the insert 266 as positioned in FIG. 14
The hole 262 on the container 260 that is unobstructed by the insert 266 as positioned in FIG. 13 is partially obstructed by the insert 266 as positioned in FIG. 14

Referring to the invention as shown in FIG. 13 and FIG. 14, the interior space of the container comprises regions 272, 274, 276, 278 of non-equal play difficulty. In the invention as shown in FIG. 13 and FIG. 14, these regions 272, 274, 276, 278 are circumscribed by the inner surface of the container and the faces of the insert.

Still referring to the invention as shown in FIG. 13 and FIG. 14, each region 272, 274, 276, 278 is a level of play difficulty. The level of play difficulty of each region 272, 274, 276, 278 is determined by the size of the opening that enables access to that region. The position of the insert determines the size of the opening that enables access to each region 272, 274, 276, 278. In the invention as shown in FIG. 13 and FIG. 14, the two positions of the insert result in a total of three distinct levels of play difficulty. The region of the easiest level of play difficulty 278 is the region with the largest opening that enables access to that region. The region of the hardest level of play difficulty 272 is the region with the smallest opening that enables access to that region.

In further detail, still referring to the invention as shown in FIG. 13 and FIG. 14, the container 260 is of a sufficient volume for an average cat, or other small animal, to play with it comfortably, such as about 100 to 6000 cubic inches. Each hole 262, 264, 268, 270 on the container 260 and the outermost vertical faces of the insert is of a sufficient size to allow an average cat, or other small animal, to put its paw—but not its head—through it, such as about 0.5 to 3 inches in diameter, or about 0.5 to 3 inches in the longest dimension.

The construction details of the invention as shown in FIG. 13 and FIG. 14 are that the container 260 and insert 266 may be made of lightweight, solid material (such as cardboard, plywood, plastic) or a fabric material stretched over a solid frame. One or more of the faces on the container 260 can be opened or detached to enable the placement, removal, or adjustment of the insert 266.

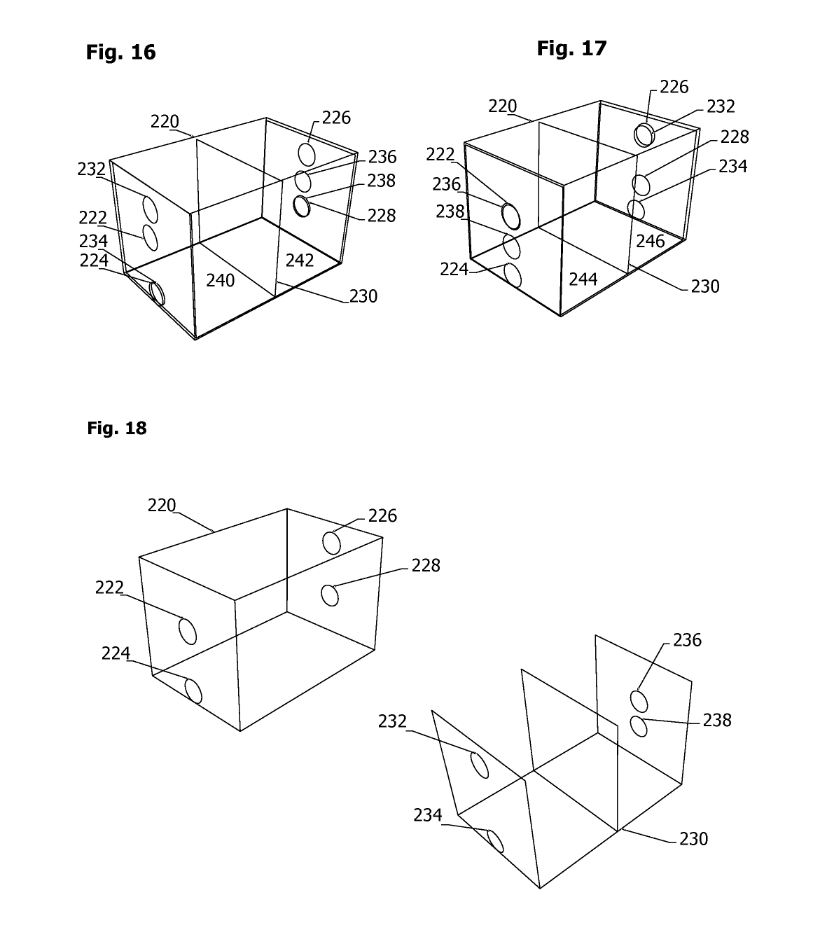

In FIG. 16 there is shown a toy having a container 220 with holes 222, 224, 226, 228 on its vertical faces and an insert 230 inside the container 220 with holes 232, 234, 236, 238 on its outermost vertical faces. The outermost vertical faces of the insert overlay the vertical faces of the container. The overlaps of the holes 234, 238 on the insert 230 and the holes 224, 228 on the container 220 result in openings that enable access to the interior of the container.

In the invention as shown in FIG. 17 the insert 230 is shown rotated 180 degrees in the horizontal plane relative to its position in FIG. 16, so that:
The holes 222, 226 on the container 220 that are obstructed by the insert 230 as positioned in FIG. 16 are unobstructed by the insert 230 as positioned in FIG. 17
The holes 224, 228 on the container 220 that are unobstructed by the insert 230 as positioned in FIG. 16 are obstructed by the insert 230 as positioned in FIG. 17

Referring to the invention as shown in FIG. 16 and FIG. 17, the interior space of the container comprises regions 240, 242, 244, 246 of non-equal play difficulty. In the invention as shown in FIG. 16 and FIG. 17, these regions 240, 242, 244, 246 are circumscribed by the inner surface of the container and the faces of the insert.

Still referring to the invention as shown in FIG. 16 and FIG. 17, each region 240, 242, 244, 246 is a distinct level of play difficulty. The level of play difficulty of each region 240, 242, 244, 246 is determined by the distance between the openings that enable access to that region and the bottom face of the container. The position of the insert determines the position of the opening that enables access to each region 240, 242, 244, 246. In the invention as shown in FIG. 16 and FIG. 17, the two positions of the insert result in a total of four distinct levels of play difficulty.

The region 240 of the easiest level of play difficulty is the region with the least distance between the hole 224 that enables access to that region and the bottom face of the container. The region 246 of the hardest level of play difficulty is the region with the greatest distance between the hole that enables access to that region and the bottom face of the container.

In further detail, still referring to the invention as shown in FIG. 16 and FIG. 17, the container 220 is of a sufficient volume for an average cat, or other small animal, to play with it comfortably, such as about 100 to 6000 cubic inches. Each hole 222, 224, 226, 228, 232, 234, 236, 238 on the container 220 and the outermost vertical faces of the insert is of a sufficient size to allow an average cat, or other small animal, to put its paw—but not its head—through it, such as about 0.5 to 3 inches in diameter, or about 0.5 to 3 inches in the longest dimension.

The construction details of the invention as shown in FIG. 16 and FIG. 17 are that the container 220 and insert 230 may be made of lightweight, solid material (such as cardboard, plywood, plastic) or a fabric material stretched over a solid frame. One or more of the faces on the container 220 can be opened or detached to enable the placement, removal, or adjustment of the insert 230.

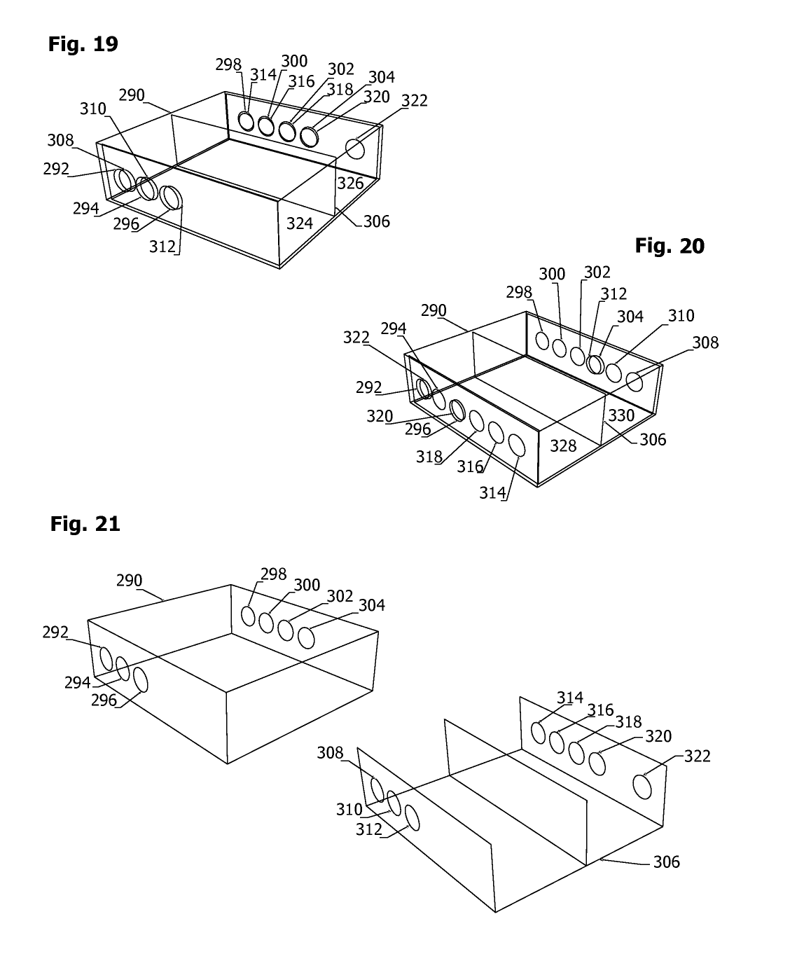

In FIG. 19 there is shown a toy having a container 290 with holes 292, 294, 296, 298, 300, 302, 304 on its vertical faces and an insert 306 inside the container 290 with holes 308, 310, 312, 314, 316, 318, 320, 322 on its outermost vertical faces. The outermost vertical faces of the insert overlay the vertical faces of the container. The overlaps of the holes 308, 312, 320 on the insert 306 and the holes 292, 296, 304 on the container 290 result in openings that enable access to the interior of the container.

In the invention as shown in FIG. 20 the insert 306 is shown rotated 180 degrees in the horizontal plane relative to its position in FIG. 19, so that:
The holes 296, 298, 300, 302 on the container 290 that are obstructed by the insert 306 as positioned in FIG. 19 are unobstructed by the insert 306 as positioned in FIG. 20

Referring to the invention as shown in FIG. 19 and FIG. 20, the interior space of the container comprises regions 324, 326, 328, 330 of non-equal play difficulty. In the invention as shown in FIG. 19 and FIG. 20, these regions 324, 326, 328, 330 are circumscribed by the inner surface of the container and the faces of the insert.

Still referring to the invention as shown in FIG. 19 and FIG. 20, each region 324, 326, 328, 330 is a distinct level of play difficulty. The level of play difficulty of each region 324, 326, 328, 330 is determined by the number of openings that enable access to that region. The position of the insert determines the number of openings that enable access to each region 324, 326, 328, 330. In the invention as shown in FIG. 19 and FIG. 20, the two positions of the insert result in a total of four distinct levels of play difficulty. The region 330 of the easiest level of play difficulty is the region with the greatest number of openings that enable access to that region. The region 324 of the hardest level of play difficulty is the region with the least number of openings that enable access to that region.

In further detail, still referring to the invention as shown in FIG. 19 and FIG. 20, the container 290 is of a sufficient volume for an average cat, or other small animal, to play with it comfortably, such as about 100 to 6000 cubic inches. Each hole 292, 294, 296, 298, 300, 302, 304, 308, 310, 312, 314, 316, 318, 320, 322 on the container 290 and the outermost vertical faces of the insert is of a sufficient size to allow an average cat, or other small animal, to put its paw—but not its head—through it, such as about 0.5 to 3 inches in diameter, or about 0.5 to 3 inches in the longest dimension.

The construction details of the invention as shown in FIG. 19 and FIG. 20 are that the container 290 and insert 306 may be made of lightweight, solid material (such as cardboard, plywood, plastic) or a fabric material stretched over a solid frame. One or more of the faces on the container 290 can be opened or detached to enable the placement, removal, or adjustment of the insert 306.

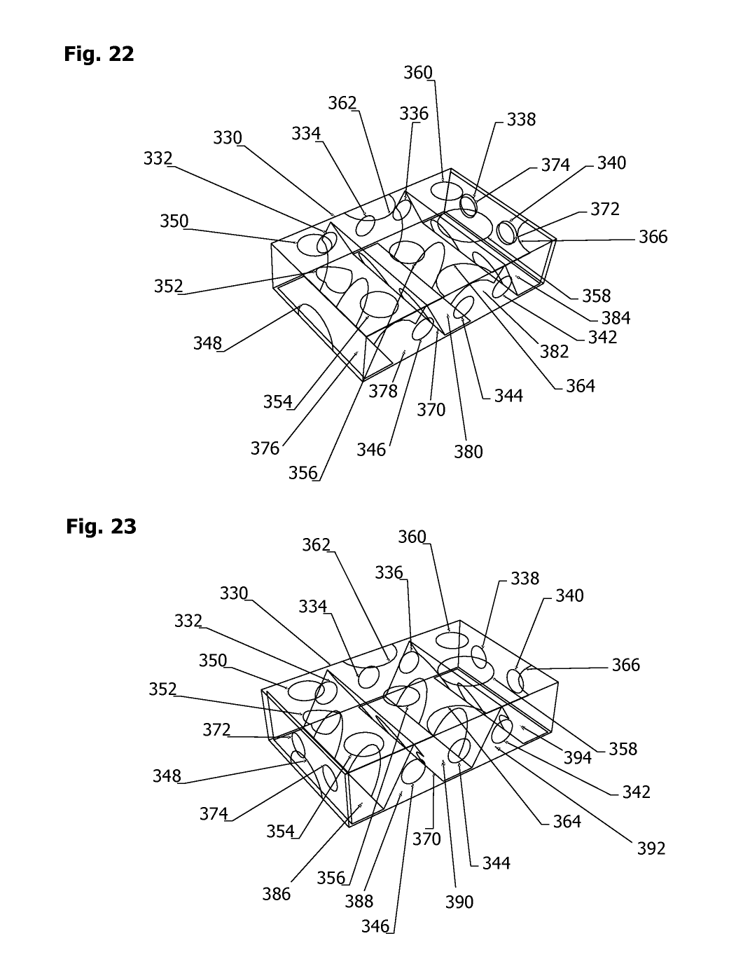

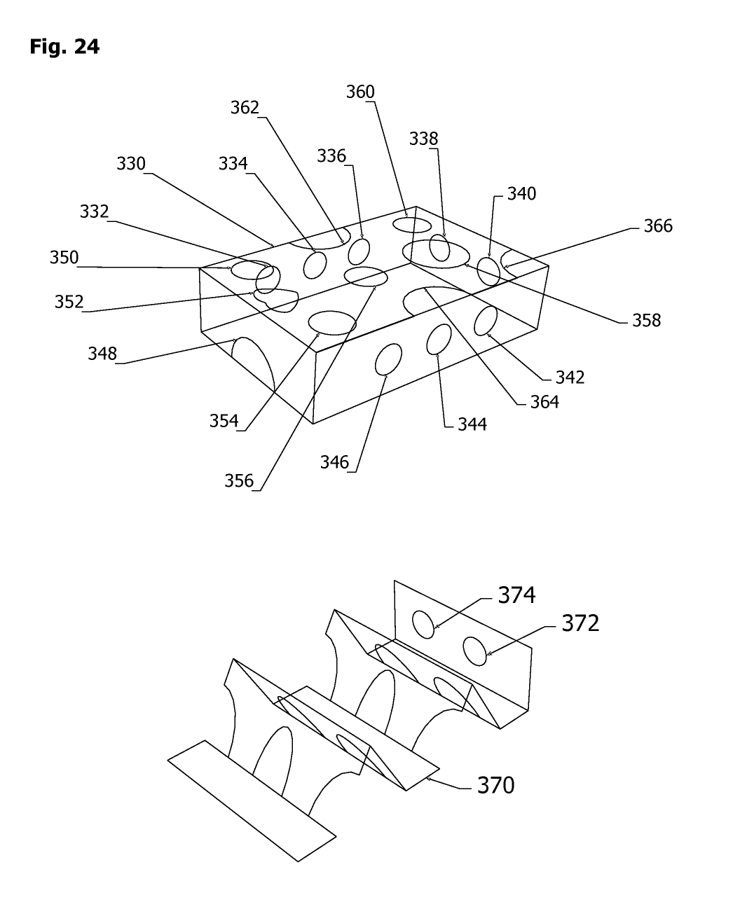

In FIG. 22 there is shown a toy having a container 330 with multiple holes 332, 334, 336, 338, 340, 342, 344, 346, 348, 350, 352, 354, 356, 358, 360, 362, 364 on its surface and an insert 370 inside the container 330 with holes 372, 374 on its outermost vertical faces. The outermost vertical faces of the insert overlay the vertical faces of the container. The overlaps of the holes 372, 374 on the insert 370 and the holes 338, 340 on the container 330 result in openings that enable access to the interior of the container.

In the invention as shown in FIG. 23 the insert 370 is shown rotated 180 degrees in the horizontal plane relative to its position in FIG. 22, so that:
The hole 348 on the vertical face of the container that is unobstructed by the insert 370 as positioned in FIG. 22 is obstructed by the insert 370 as positioned in FIG. 23

Referring to the invention as shown in FIG. 22 and FIG. 23, the interior space of the container comprises regions 378, 380, 382, 384, 386, 388, 390, 392, 394, 396 of non-equal play difficulty. In the invention as shown in FIG. 22 and FIG. 23, these regions 378, 380, 382, 384, 386, 388, 390, 392, 394, 396 are circumscribed by the inner surface of the container and the faces of the insert.

Still referring to the invention as shown in FIG. 22 and FIG. 23, each region 378, 380, 382, 384, 386, 388, 390, 392, 394, 396 is a level of play difficulty. The level of play difficulty of each region 378, 380, 382, 384, 386, 388, 390, 392, 394, 396 is determined by a combination of the factors that determine the levels of play difficulty of regions in the invention as shown in FIGS. 1, 2, 3, 4, 5. The position of the insert determines the number and position of the openings that enable access to each region 378, 380, 382, 384, 386, 388, 390, 392, 394, 396. In the invention as shown in FIG. 22 and FIG. 23, the two positions of the insert result in a total of five distinct levels of play difficulty.

In further detail, still referring to the invention as shown in FIG. 22 and FIG. 23, the container 330 is of a sufficient volume for an average cat, or other small animal, to play with it comfortably, such as about 100 to 6000 cubic inches. Each hole 332, 334, 336, 338, 340, 342, 344, 346, 348, 350, 352, 354, 356, 358, 360, 362, 364, 372, 374 on the container 330 and the outermost vertical faces of the insert is of a sufficient size to allow an average cat, or other small animal, to put its paw—but not its head—through it, such as about 0.5 to 3 inches in diameter, or about 0.5 to 3 inches in the longest dimension.

The construction details of the invention as shown in FIG. 22 and FIG. 23 are that the container 330 and insert 370 may be made of lightweight, solid material (such as cardboard, plywood, plastic) or a fabric material stretched over a solid frame. One or more of the faces on the container 330 can be opened or detached to enable the placement, removal, or adjustment of the insert 370.

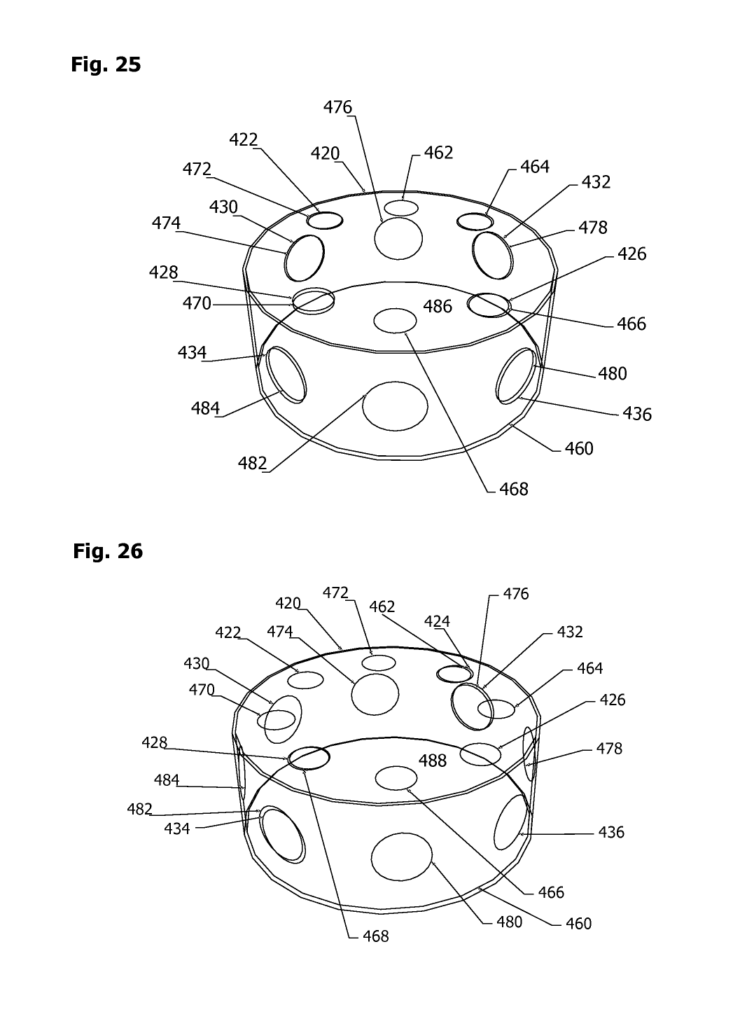

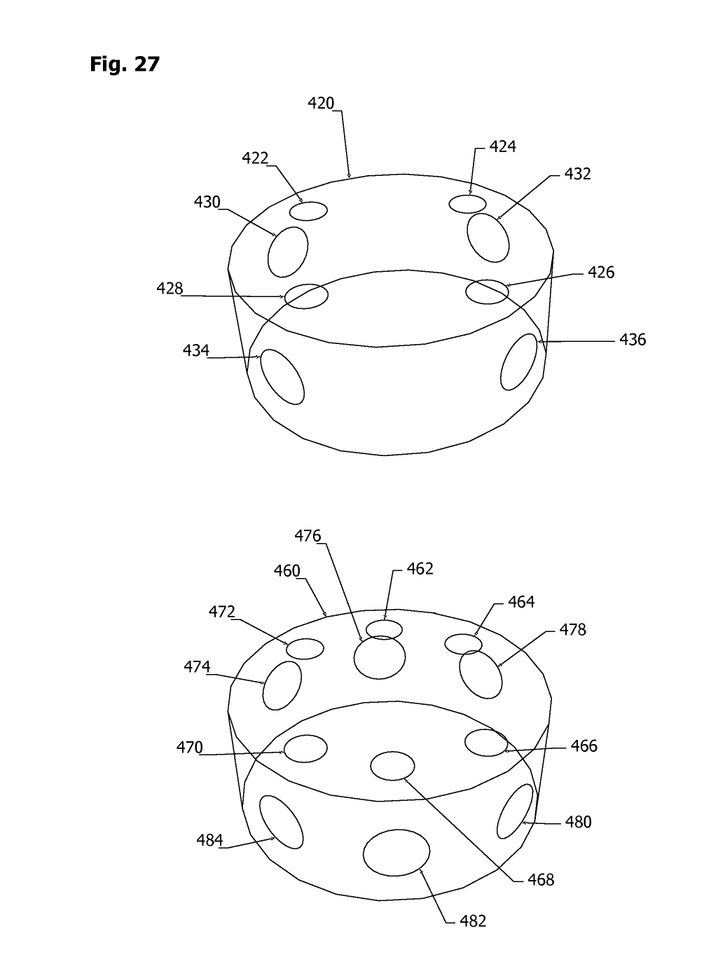

In FIG. 25 there is shown a toy having a container 420 with holes 422, 424, 426, 428, 430, 432, 434, 436 on its vertical and top faces and an insert 460 inside the container 420 with holes 462, 464, 468, 470, 472, 474, 476, 478, 480, 482, 484 on its vertical and top faces. The vertical face of the insert overlays the vertical face of the container. The overlaps of the holes 462, 464, 468, 470, 472, 474, 476, 478, 480, 482, 484 on the insert 460 and the holes 422, 424, 426, 428, 430, 432, 434, 436 on the container 420 result in openings that enable access to the interior of the container.

In the invention as shown in FIG. 26 the insert 460 is shown rotated in the horizontal plane relative to its position in FIG. 25, so that:
The holes 422, 426, 430, 436 on the container 420 that are unobstructed by the insert 460 as positioned in FIG. 25 are obstructed by the insert 460 as positioned in FIG. 26

Referring to the invention as shown in FIG. 25 and FIG. 26, the interior space of the container comprises regions 486, 488 of non-equal play difficulty. In the invention as shown in FIG. 25 and FIG. 26, these regions 486, 488 are circumscribed by the inner surface of the container and the faces of the insert.

Still referring to the invention as shown in FIG. 25 and FIG. 26, each region 486, 488 is a distinct level of play difficulty. The level of play difficulty of each region 486, 488 is determined by the number of openings that enable access to that region. The position of the insert determines the number of openings that enable access to each region 486, 488. In the invention as shown in FIG. 25 and FIG. 26, the two positions of the insert result in a total of two distinct difficulty levels.

The region of the easiest level of play difficulty 486 is the region with the greatest number of openings that enable access to that region. The region of the hardest level of play difficulty 488 is the region with the least number of openings that enable access to that region.

In further detail, still referring to the invention as shown in FIG. 25 and FIG. 26, the container 420 is of a sufficient volume for an average cat, or other small animal, to play with it comfortably, such as about 100 to 6000 cubic inches. Each hole 422, 424, 426, 428, 430, 432, 434, 436, 462, 464, 468, 470, 472, 474, 476, 478, 480, 482, 484 on the container 420 and the faces of the insert is of a sufficient size to allow an average cat, or other small animal, to put its paw—but not its head—through it, such as about 0.5 to 3 inches in diameter, or about 0.5 to 3 inches in the longest dimension.

The construction details of the invention as shown in FIG. 25 and FIG. 26 are that the container 420 and insert 460 may be made of lightweight, solid material (such as cardboard, plywood, plastic) or a fabric material stretched over a solid frame. One or more of the faces on the container 420 can be opened or detached to enable the placement, removal, or adjustment of the insert 460.

The advantages of the present invention include, without limitation, multiple levels of play difficulty, and the method whereby play difficulty can be adjusted according to the skill level of the player. The toy will remain challenging and interesting to the player for a longer period of time compared to toys with single levels of play difficulty.

While the preceding description of the invention enables a person of ordinary skill to make and use what is presently considered to be the best mode of the invention, it will be appreciated that various modifications, variations, configurations, and equivalents exist, and may be implemented with respect to the above described embodiments, methods, and examples. The invention is therefore not limited by the embodiments, methods, and examples described herein, but includes all embodiments and methods within the scope and spirit of the invention.

What is claimed is:

1. A toy for a cat or other small animal, comprising
a plurality of surfaces, henceforth referred to as a “container”, that circumscribe a three-dimensional interior space;
distinct regions of space within the container that are fully or partially separated by one or more partitions;
a plurality of holes in one or more of the surfaces of the container that enable access to the regions of space within the interior of the container;
each of the distinct region of space within the interior of the container having a distinct degree of play difficulty, based on one or more of the following factors:
a) The size of the holes that enable access to each region; where, holding other factors constant, a region with a smaller hole that enables access to that region has a greater level of play difficulty than a region with a larger hole that enables access to that region;
b) The number of holes that enable access to each region; where, holding other factors constant, a region with a lesser number of holes that enable access to that region has a greater level of play difficulty than a region with a greater number of holes that enable access to that region;
c) The position of the holes relative to the edges of the container; where,
holding other factors constant, a region with a greater distance between a hole on a vertical face of the container and the bottom edge of the container has a greater level of play difficulty than a region with a lesser distance between a hole on a vertical face of the container and the bottom edge of the container;
holding other factors constant, a region with a greater distance between a hole on the top face of the container and the nearest edge of the container has a greater level of play difficulty than a region with a lesser distance between a hole on the top face of the container and the nearest edge of the container;
d) The position of the holes relative to each other; where, holding other factors constant, a region with a greater distance between the holes that enable access to that region has a greater level of play difficulty than a region with a lesser distance between the holes that enable access to that region.

2. A toy for a cat or other small animal, in accordance with claim 1, wherein the distinct regions within the interior space of the container are fully or partially separated from the other region(s) by one or more removable inserts positioned inside the container.

3. A toy for a cat or other small animal, in accordance with claim 1, wherein the distinct regions within the interior space of the container are fully or partially separated from the other region(s) by one or more surfaces of the container that protrude into the interior space of the container.

4. A toy for a cat or other small animal, in accordance with claim 1, wherein the container comprises multiple adjoined containers.

5. A toy for a cat or other small animal, in accordance with claim 1, wherein the level of play difficulty of one or more regions of the interior space of the container may be altered by fully or partially obstructing, or fully or partially uncovering, one or more of the holes in the surface of the container.

6. A toy for a cat or other small animal, in accordance with claim 2, wherein the position of one or more of the insert(s) relative to the container can be changed to fully or partially obstruct, or fully or partially uncover, one or more holes in the surface of the container, thereby altering the level play difficulty of one or more of the regions of the interior space of the container.

7. A toy for a cat or other small animal, in accordance with claim 1, wherein each region of the interior space of the container with a distinct level of play difficulty is distinguished by color from the other regions of the interior space of the container.

8. A toy for a cat or other small animal, in accordance with claim 1, wherein one or more surfaces of the container may be fully or partially detached to enable access to the interior space of the container.
